(19) United States
(12) Patent Application Publication
(10) Pub. No.: US 2009/0051090 A1
(43) Pub. Date: Feb. 26, 2009

(54) Pipe welding holding device and method for holding pipes with flanges in place during welding to vessel walls and other structures

(76) Inventor: Robbie Dean Barnes, JR., Pasadena, TX (US)

Correspondence Address: Charles E. Frost, Jr.;Chamberlain, Hrdlicka, White, Williams &, Martin, P.C., 1200 Smith St., Suite 1400, Houston, TX, 77002, US

(21) Appl. No.: 11/894,323

(22) Filed: Aug. 21, 2007

(51) Int. Cl. B23K 37/04; B23K 37/053; B25B 11/02

(52) U.S. Cl. 269/8

(57) ABSTRACT

A pipe welding holding device and a method for holding pipes with flanges in place during welding to vessel walls and other structures. The invention provides an easy-to-use mechanical device, and a method, to hold the flange connected to a pipe in place during welding and enables the welder to accurately and reliably set the flange and pipe so that much fewer errors are made in welding than at present, and a method for using said device.

### RELATED APPLICATIONS

None

### COPYRIGHT STATEMENT

A portion of the disclosure of this patent document contains material which is subject to copyright protection. The copyright owner has no objection to the facsimile reproduction by anyone of the patent document or the patent disclosure, as it appears in the Happened and Trademark office patent file or records, but otherwise reserves all copyright rights whatsoever.

### BACKGROUND OF THE INVENTION

1. Field of the Invention

The present invention relates to a device and method for holding nozzles and pipes, and other similar material, in place while being welded to tanks and other vessels in chemical plants and refineries, oil refineries, oil field plants, barges, ships, heating boilers, some railroad cars, nuclear power plants, electrical power plants, water purification plants, sewer plants, off-shore rigs, and other similar facilities.

2. Background of the Invention

In chemical plants and refineries, oil refineries, other industrial plants, nuclear and electrical power plants, barges, ships, water purification plants, sewer plants, some railroad cars, and in oil and gas production facilities and pipelines, nozzles and pipes are connected to tanks, refracting vessels, and other larger pipes, by being welded to the “shell” of the particular tank, vessel, or pipe. For many decades such welding has been accomplished by a two-person team. For ease of description, the welding of a nozzle to a tank will be described; the process is similar for vessels or pipes onto which a nozzle or pipe is to be attached.

The traditional approach is for the two-person team to hand-set the nozzle, pipe, or other matter to be welded to the wall of the tank or other vessel, as follows. The team first measures, with a tape measure, the distance that the nozzle is to extend (project) from the wall of the vessel. The team then uses a leveling device, such as a “torpedo level,” to ensure that the pipe extends horizontally, or some other desired angle, from the tank.

The nozzle or pipe will already have a flange attached to one end. The flange typically has a plurality of eight or more holes equidistant around the circumference of the flange. The team positions the nozzle and its attached flange so that a line drawn through the center of two of the holes is approximately parallel (horizontal) to the ground; this includes using a level to attempt to ensure that a line drawn through the center of the holes is parallel to the ground.

Once these steps have been accomplished, one of the two members of the team—the welder—prepares to weld the nozzle to the tank wall. The other member of the team—the assistant—holds the nozzle as close to the chosen position, and as horizontal, as possible, while the welder welds the nozzle to the tank wall. The assistant, while attempting to hold the nozzle and flange level during the welding, must turn his (or her) head away so as not to be blinded by the welding torch light.

This process frequently results in inaccurate welds, which must be broken or cut and re-welded two, three, or four times before an acceptable, albeit frequently not perfectly accurate, weld has been obtained. An acceptable weld is achieved when the nozzle is approximately parallel to the ground or at the angle desired, and at approximately the length of projection desired from the tank wall, and the two holes at the topmost portion of the flange are approximately horizontal to the ground.

Frequently even after an acceptable weld is achieved, when a nozzle or pipe with a corresponding flange is connected with the nozzle and flange that has been welded to the tank wall, the holes do not line up to the ideal level of accuracy and the bolts and the nozzle and flange must be slightly twisted to fit the connecting nozzle and flange; this can result in long-term damage to the nozzle because of the stress to the twisted pipe, and to the bolts connecting the flanges. Sometimes the welding team finds it necessary to drive the bolts holding the flanges in place with a hammer, which damages the threads of the bolts and thereby weakens them and makes them more susceptible to breaking when stressed.

In addition, during the welding the assistant frequently is burned by molten pieces of metal that drop from the welding torch on his/her arm, and/or is shocked by the circuit from the welding machine. The welding assistant also frequently will have his or her eyes burned by a welding flash.

Although a patent by Blewett, U.S. Pat. No. 2,733,330, disclosed a welder's work stand having an adjustable support with V, the disclosed device does not provide the same level of support for the pipe and flange, does not provide the level of control of the pipe and flange so that first welds will generally be successful, does not provide magnets to hold the device and the flange in place which thereby risks the stand being jarred or knocked over, and would be quite cumbersome if it were used by welders in industry. It is not used by welders in industry. The present invention, by contrast, provides substantial support for the pipe and flange, provides control to obtain precise settings so that first welds are generally successful, provides magnets to hold the device in place thereby effectively removing the risk of the device being jarred during set-up and welding, and is relatively lightweight and easily moved and set up by one person.

A patent by Jusionis, U.S. Pat. No. 5,310,982, discloses a T-joint welding device for welding a branch tube to a header tube clamp. It is not practical for tanks, vessels and a host of other things to which pipes and nozzles with flanges would be welded, and does not provide the support and control provided by the present invention. It also is not used in industry to the best of this inventor's knowledge.

The foregoing patent and other information reflect the state of the art of which the inventor is aware, and are tendered with a view toward discharging the inventor's duty of candor in disclosing information that may be pertinent to the patentability of the present invention. The foregoing do not teach or render obvious, singly or when considered in combination, the inventor's claimed invention. The fact that the Blewett patent was awarded over 50 years ago but is generally not used in the welding industry illustrates the need for and desirability of the present invention.

### OBJECTS AND SUMMARY OF THE INVENTION

It is the object of the invention to stabilize and accurately set the nozzle and flange so that the welding process results in an accurate placement of the nozzle and flange the first time it is welded to the tank wall, and reduce or eliminate the errors that result in the weld having to be redone. It is a further object of the invention to provide a stabilizing device that will enable the welder to reliably and accurately set the pipe or nozzle at the desired distance and angle. It is a further advantage of the invention to provide a safer method for conducting the aforesaid welding that minimizes or eliminates the burns and shocks frequently experienced by the welding helper described above. It is a further advantage of the invention to provide the aforesaid benefits of the invention at a relatively low cost, including eliminating the need for an assistant to hold the nozzle or pipe in place during the welding. Another advantage of the invention is to significantly reduce the amount of time required to perform the welding operation.

The apparatus of the present invention enables one person—the welder—to more accurately set the nozzle and flange by providing an adjustable holder for the nozzle and flange attached to the wall of the vessel or tank using magnets that may be activated (polarized) and de-activated (de-polarized). This results in accurate first-time welds. The apparatus can be easily assembled and utilized by one person rather than two people. The device may be readily dismantled and moved to another work site.

### BRIEF DESCRIPTION OF THE DRAWINGS

FIG. 1 provides an illustration of the basic design of the invention.

FIG. 2 provides an illustration of one form of preferred embodiment that provides for flexibility in placement of the device on rounded walls of vessels such as tanks, and provides for holding the flange more securely in place.

FIG. 3 provides an illustration of a preferred embodiment showing the flange in the flange seat channel piece, with the grounding wedge in place.

FIG. 4 illustrates a preferred embodiment with a hand crank at the end of the projection angle pieces.

FIG. 5 illustrates an embodiment with a band, instead of screws illustrated in previous figures, to hold the flange in place.

FIG. 6 illustrates an embodiment that includes a device for holding the pipe or nozzle to which the flange is attached more precisely in place during welding.

### DETAILED DESCRIPTION OF THE INVENTION

The present invention now will be described more fully hereinafter with reference to the accompanying drawings in which a preferred embodiment of the invention is shown. This invention, however, may be embodied in many different forms and should not be construed as limited to the embodiment set forth herein; rather, this embodiment is provided so that this disclosure will be thorough and complete, and will fully convey the scope of the invention to those skilled in the art. (Like numbers refer to like elements throughout.)

The invention is a device to hold the flange and pipe or nozzle in place during the welding process. The invention can be set in place easily by one person. It also is simple in design and easy to assemble and disassemble to move to a new location for other welding work. The invention consists of the following:

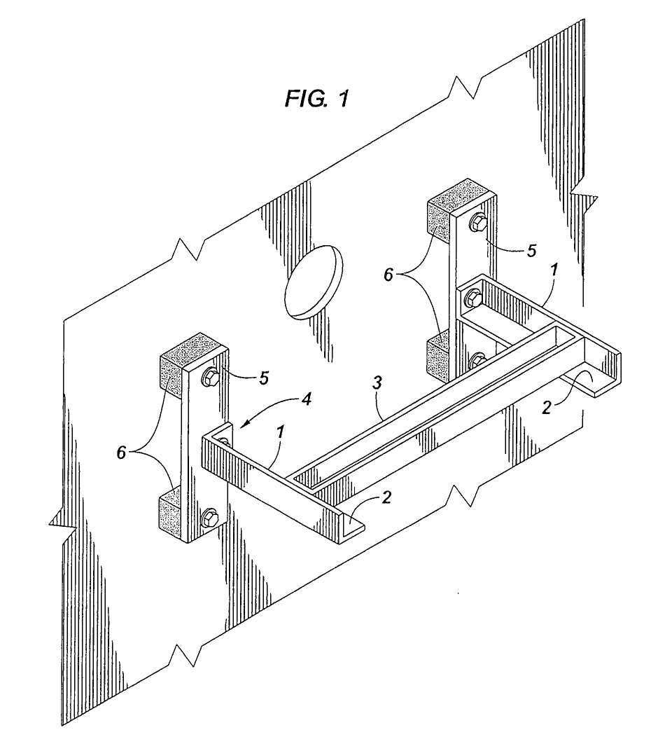

The basic device, FIG. 1, consists of a frame to hold a pipe or nozzle with flange or similar device using two angle pieces (1) hereinafter the “projection angle piece,” constructed of steel, stainless steel, carbon steel, steel alloy, fibre-metal, other high-temperature-resistant metal, or wood, which face each other to provide a shelf (2) into which a channel piece (3) to hold the flange, hereinafter the “flange seat channel piece,” can be set. The projection angle pieces are each attached perpendicularly (4) to a connecting piece (5) on which one or a plurality of magnets (6) are attached to hold the device securely to the shell of the vessel to which the pipe with flange is to be welded.

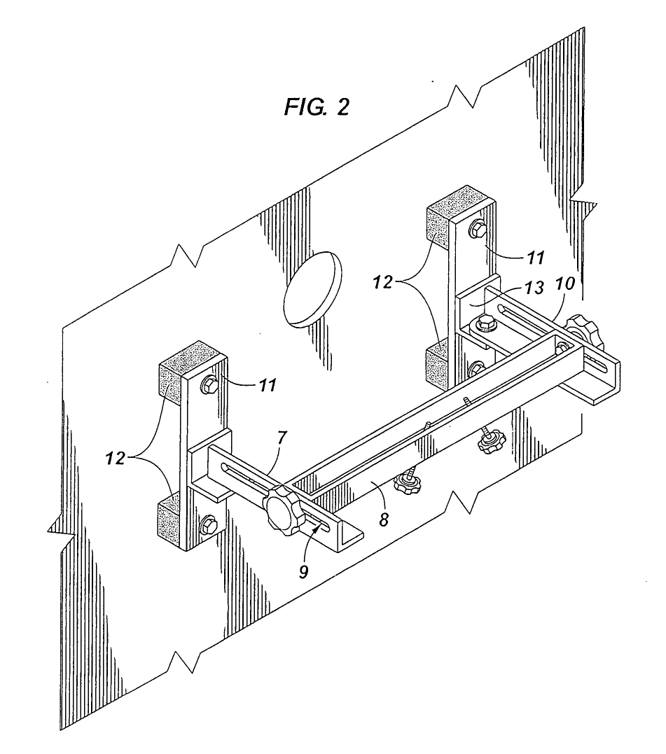

A preferred embodiment of the device consists of the following. FIG. 2. A projection angle piece (7) constructed from material selected from the group consisting of steel, carbon steel, steel alloy, fibre-metal, other high-temperature-resistant metal, and wood, measuring in width ranging from two to six inches, and in length ranging from 12 to 24 inches, and in depth ranging from ⅛ to ½ inches, is provided, said projection angle piece being bent 90 degrees in the middle of the width to form a shelf on which one end of a flange seat channel piece (8) to hold the flange rests (described below). The side of each of said projection angle pieces has a linear lengthwise elongated aperture (9) measuring one sixteenth to three-eighths inch in width in the middle extending the entire length of the piece except one inch on each end, into which connecting screws or similar screwable extensions may be placed as provided below.

A second projection angle piece (10) that is identical to the first described above, except that it faces the opposite direction, is provided so that together they provide a supporting shelf for a flange seat channel piece to hold the flange, as described below.

Each of said projection angle pieces is secured at one end of the shelf portion of the projection angle piece, by a bolt and nut, or other threaded fastener or attaching device, perpendicularly to a pivot support piece (13) in a manner permitting the projection angle piece to rotate horizontally to adjust for a rounded surface such as a vessel, tank or pipe. The pivot support piece is connected by welding, glue, threaded fasterner, other fastener or attaching piece, or other means to a connector piece (11) measuring in length from 6 to 24 inches, in width from one to six inches, and in depth from ⅛ to ½ inch, and constructed of material selected from the group consisting of steel, carbon steel, steel alloy, stainless steel, fibre-metal, other high-temperature resistant metal, and wood, which in turn is connected to a plurality of one or more magnets (12) to hold the entire device in place against the shell of the vessel, tank or pipe to which the pipe connected to the flange is to be welded. The magnets must have sufficient magnetic strength to hold the entire device and the pipe with flange securely in place during the preparation and welding process.

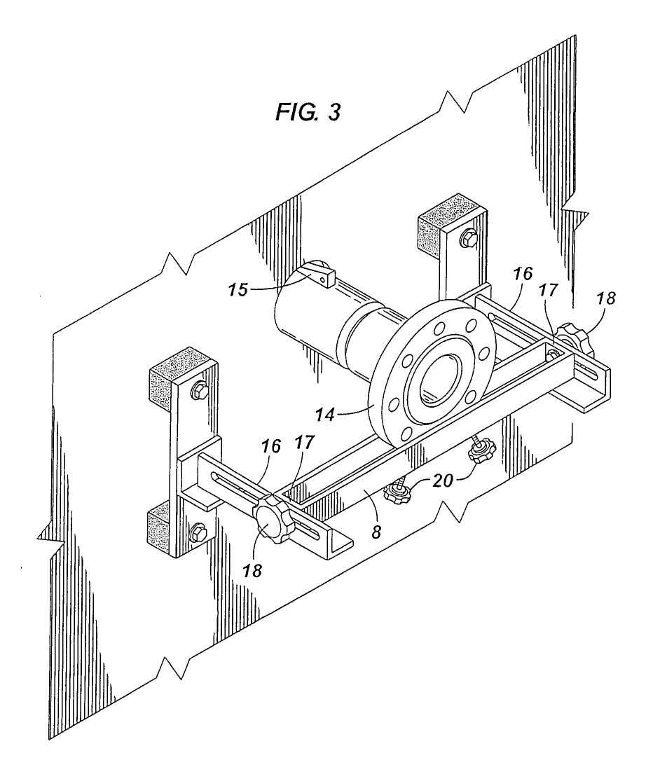

The flange seat channel piece (8), as shown in FIG. 3, is provided to support and hold the flange in place. It is constructed from a material chosen from the group consisting of steel, carbon steel, steel alloy, stainless steel, and wood, and its length ranges from 8 to 36 inches, and is constructed to provide a channel ranging from one to three inches in width into which a flange (14) may be placed. The flange seat channel piece is slidably connected at each end perpendicular to the projection angle pieces (16). Each end of the flange seat channel piece is bent upward to be perpendicular to the rest of the flange seat channel piece (17), and an aperture is provided in each such perpendicular portion (at each end), into which a fastener may be placed (18).

In one embodiment, apertures measuring one-sixteenth to one-half inch in diameter are also drilled into the bottom surface of the flange seat channel piece at equal distances from the center of the flange seat channel piece every one to two inches, said apertures being drilled at an angle of 10 to 40 degrees from the perpendicular pointed toward a line perpendicular to the center of the flange seat channel piece to permit placement of screws or other threaded devices as described below. The flange is held in place within the channel by two screws or other threaded devices (20) of equal length ranging from two to six inches in length and a diameter ranging from one-eighth to one-half inch, which extend from the floor side upwards through the apertures in the bottom of the flange seat channel piece at an angle ranging between 10 and 40 degrees from perpendicular and pointing towards a line drawn perpendicular to the middle of the channel, one threaded device placed on the left side of the flange and the other on the right side of the flange, and each threaded device adjusted upward to hold the flange in place such that it will not move laterally to the left or the right within the channel during welding.

The exact distance that the nozzle or pipe will project from the vessel or other object to which it will be welded is set by measuring the desired distance, moving the flange seat channel piece to the desired distance, and then securing the flange seat channel piece in place by using a screw, bolt and nut, or other fastener (18) at each end of the flange seat channel piece, each of which is placed through the lengthwise aperture parallel to the ground in the projection angle pieces at the desired distance and through the aperture at the end of the flange seat channel piece and tightened.

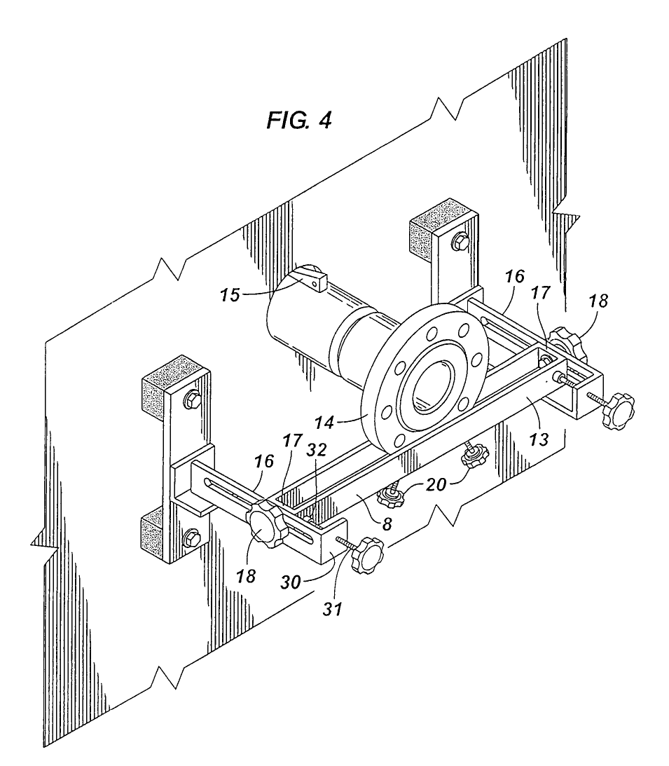

An additional element provided in some embodiments (FIG. 4) is an adjuster crank designed to provide additional control of the placement of the flange seat channel piece. An end piece (30) is added or attached to end of each of the projection angle pieces on the opposite end from the connector piece and magnets, and a threaded aperture is placed in the middle of the each of the turned-up end pieces. A threaded device, such as a screw with a handle or crank on the end to provide easier control and handling, (31) is placed through said threaded apertures and connected to the flange seat channel piece (32).

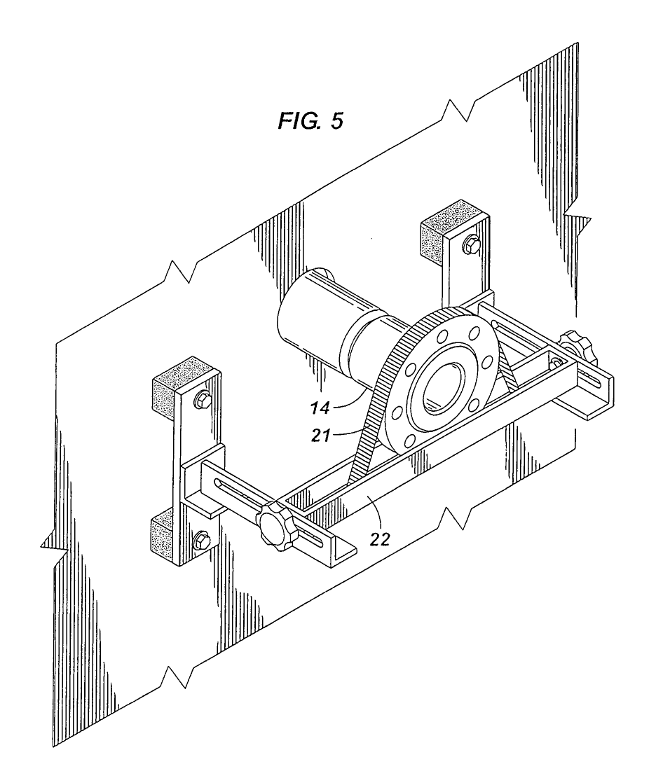

In another embodiment, FIG. 5, a securing band (21) is used instead of threaded devices to hold the flange in place. Two apertures are provided in the bottom of the flange seat channel piece (22), and the band is fed through the apertures, extended around the flange, and secured firmly underneath so that the flange will not move during welding.

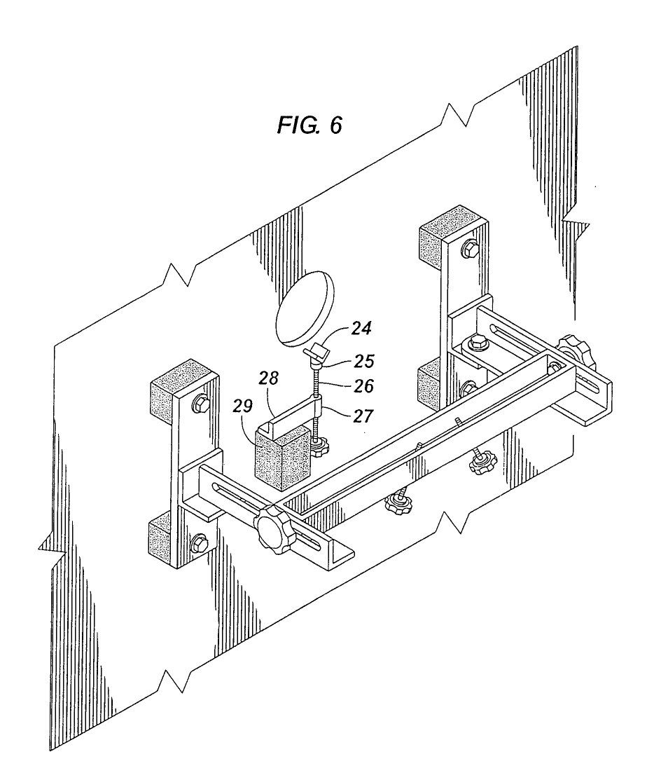

The nozzle or pipe may be further positioned and held in place by placing under the pipe one or more inches from the wall of the vessel, tank or pipe to which the pipe or nozzle is to be welded a device (FIG. 6) consisting of a piece of metal or wood formed into a V-shape (24) attached in the middle of its underside (25) to a screwably adjustable threaded rod (26), which is situated in one end of an arm consisting of a metal piece extending in the range of two to four inches (27), the interior of said end of the arm being threaded to permit the rod to be screwably adjusted. The other end of the arm (28) is connected to one or a plurality of magnets (29) having sufficient power to hold the entire device securely to the outer wall of the vessel to which the pipe or nozzle is to be welded.

In one embodiment of the invention, the magnets are of a design that can be turned on and off (magnetized and demagnetized) at the turn of a switch. As one example of said type of magnet, Bug-O Systems and Ludlow System produce said magnets.

As shown in FIG. 3, a grounding wedge is also provided. The grounding wedge is placed in the hole of the metal wall into which the nozzle or pipe is being welded (15). A principle purpose of the grounding wedge is to reduce the risk of the welder damaging the magnets because of the welding arc current.

The invention also consists of a method for preparing nozzles and clients for welding two vessels using the device described herein. The method comprises of the steps of mounting the flange of a pipe or nozzle into a flange seat channel piece, adjusting the flange seat channel piece a desired distance from the shell of the vessel onto which the pipe or nozzle is to be welded, securing the flange so that it will not move, securing the flange seat channel piece to a projection angle piece on one end and a projection angle piece on the other end so that it will not move, mounting the device described herein to the vessel shell using magnets, further securing the pipe or nozzle using the v-shaped device described here in, and welding the pipe or nozzle to the vessel shell.

1. A pipe welding holding device, comprising
a piece constructed from material selected from the group consisting of steel, stainless steel carbon steel, steel alloy, fibre-metal, other high-temperature-resistant metal, and wood, constructed to provide a channel into which a flange connected to a pipe may be placed, hereafter called a “flange seat channel piece,” to hold the flange in place during welding;
said channel piece being placed on angle pieces at each end of the channel piece, said angle pieces constructed of material selected from the group consisting of steel, carbon steel, steel alloy, fibre-metal, other high-temperature-resistant metal, and wood, and hereafter called “projection angle piece” or pieces;
each of said projection angle pieces being connected perpendicularly at the same end to a connecting piece constructed of material selected from the group consisting of steel, steel alloy, carbon steel, other high-temperature-resistant metal, fibre-metal, and wood;
said connecting pieces connected to one or a plurality of magnets with sufficient magnetic strength to hold the pipe welding holding device to the side of the metal structure into which the steel pipe connected to the flange is to be welded.

2. A pipe welding holding device as in claim 1, comprising:
a projection angle piece constructed of material selected from the group consisting of carbon steel, steel, steel alloy, fibre-metal, other high-temperature-resistant metal, and wood, measuring in the range of two to six inches wide and in the range of 12 to 24 inches in length and in the range of ⅛ to ½ inch in depth;
a second projection angle piece constructed of material selected from the group consisting of steel, carbon steel, steel alloy, fibre-metal, other high-temperature-resistant metal, and wood, measuring in the range of two to six inches wide, in the range of 12 to 24 inches in length and in the range of ⅛ to ½ inches in depth;
each of said projection angle pieces being angled 90 degrees in the middle of the width to form a shelf portion facing inwards into which a flange seat channel piece may be placed;
said projection angle pieces being set parallel to the ground;
the side of each of said projection angle pieces having an elongated linear aperture one-eighth to one-half inch wide in the middle of the side of said projection angle piece, extending the entire length of said projection angle piece except one inch on each end;
each of said projection angle pieces being secured at one end of the shelf portion of projection angle piece, by a bolt and nut, or other threaded fastener or attaching device, perpendicularly to a pivot support piece such that the projection angle piece can rotate horizontal to the ground to adjust for a rounded surface such as vessels and pipes, said pivot support piece being connected by welding, glue, threaded fastener, or other fastener or attaching piece, or other means, perpendicularly to a connector piece constructed from material from the group consisting of steel, stainless steel, carbon steel, steel alloy, fibre-metal, other high-temperature-resistant metal, and wood, ranging in width from one to six inches, ranging in length from 6 to 24 inches, and ranging in depth from ⅛ to ½ inch in depth, extending perpendicular from said projection angle piece and vertical to the ground;
each of said connector pieces having one or more magnets affixed to it on the side of the connector piece closest to the shell of the vessel to which the pipe or nozzle is to be welded;
said magnets having magnetic “strength” sufficient to hold the device in place on the side of the shell of the vessel to which the pipe or nozzle is to be welded;
a flange seat channel piece measuring a range of 8 to 36 inches in length shaped to provide a channel one to three inches in width into which a flange connected to said pipe or nozzle may be placed to hold the flange in place during welding;
one inch of each end of said steel channel piece being bent 90 degrees perpendicular upwards;
an aperture being provided into said one-inch perpendicular piece at each end of said steel channel piece;
said apertures being in the range of one-sixteenth to three-eights inch in diameter;
each end of said flange seat channel piece being situated in said projection angle pieces, with said flange seat channel piece being adjustable to the same distance from the shell of the steel vessel as that to which the flange at the end of the nozzle or pipe is to extend;
a threaded fastener being placed through the aperture in the perpendicular side of the left angle piece and through the aperture on the left end of said flange seat channel piece to fasten the channel at the desired distance from the metal wall of said vessel;
a threaded fastener being placed through the aperture in the perpendicular side of the right angle piece and through the aperture on the right end of said steel channel piece to fasten the channel at the desired distance from the metal wall of said vessel.

3. A pipe welding holding device as in claim 1 or claim 2, further comprising of said magnets having the capability to be magnetized and demagnetized by turning a switch on and off.

4. A pipe welding holding device as in claim 1 or claim 2, further comprising
a securing band, chosen from the group consisting of steel, rubber, plastic, or cloth, being one-quarter to three inches in width, placed around the edge of the flange;
an aperture in the bottom of the flange seat channel piece through which one end of the band or belt is threaded;
a second aperture in the bottom of the flange seat channel piece through which the other end of the band or belt is threaded; and
a fastener attached to the portions of the band or belt under the flange seat channel piece to hold the band or belt securely in place, thereby holding the flange in place during welding.

5. A pipe welding holding device as in claim 1 or claim 2, further comprising apertures for screws or other threaded devices in the bottom of the channel of said flange seat channel piece at equal distances from the center of the channel piece beginning two inches from the center and being placed every one to two inches thereafter from the center;
said apertures being in the range of one-eighth to one-half inch in diameter;
said apertures being placed at an angle of 10 to 40 degrees from perpendicular pointed toward the center of a line drawn from the center of the flange seat channel piece;
said apertures being drilled such that screws or other threaded devices may be screwably placed within them;
a screw or other threaded device two to six inches in length, said screw or other threaded device being provided from the underside of said flange seat channel piece (nearest the floor) in one of said apertures located to the left of the center of said flange seat channel piece,
a second screw or other threaded device of the same length as the first screw or other threaded device, which is provided from the underside of said flange seat channel piece into one of said apertures located an equal distance to the right of the center of said flange seat channel piece as the aperture in which the first screw or other threaded device is provided is from the left of said center;
said screws or other threaded devices being adjusted to hold the flange at the end of said pipe or nozzle securely in place so that it will not move to the left or right within the channel.

6. A pipe welding holding device as in any of claim 1 or claim 2, further comprising:
a piece of metal or wood two ranging in length from two to six inches and one to two inches in width, angled in the middle of the length to form a V-shaped piece, the underside of the middle of said piece being attached to a screwably adjustable threaded rod;
said screwably adjustable threaded rod being situated in one end of an arm consisting of a metal piece extending in length in the range of two to four inches, the interior of said end of the arm being threaded to permit the rod to be screwably adjusted;
and the other end of said arm being connected to one or a plurality of magnets having sufficient strength to hold the entire device securely to the outer wall of the vessel to which the pipe or vessel is to be welded;

7. A pipe welding holding device as in any of claims 1 or 2 further comprising:
a flat piece of steel in the shape of a triangle;
said steel triangular piece measuring approximately 1½ inches on two sides and 1 inch on the third side;
said steel triangular piece being approximately one-sixteenth to one-eighth inch thick;
and said steel triangular piece being placed in the hole where the pipe of nozzle is to be welded between the edge of the hole and the pipe or flange to act as a ground to prevent damage to the magnets.

8. A pipe welding device as in any of claims 1 or 2, further comprising adjuster hand crank devices attached to each projection angle piece on the end farthest from the connector piece and magnets;
each of said hand cranks consisting of a threaded device with a handle or crank attached one end;
said threaded devices being screwably placed through a threaded aperture placed in the middle of end pieces attached or added to the end of the projection angle pieces;
said hand crank being further connected to the flange seat channel pieces.

9. A method for preparing nozzles and pipes for welding to vessels using the device described in any one of claims 1, 2, 3, 4, 5, 6, 7, and 8, comprising the steps of
mounting the flange of a pipe or nozzle into a flange seat channel piece;
adjusting said flange seat channel piece a desired distance from the shell of the vessel onto which the pipe or nozzle is to be welded;
securing said flange such that it will not move;
securing the flange seat channel piece to a projection angle piece on one end and a projection angle piece on the other end such that it will not move;
mounting said device described in any one of claims 1, 2, 3, 4, 5, 6, 7, and 8 to the vessel shell using magnets;
further securing said pipe or nozzle using the device described in claims 6 or 7; and
welding the pipe or nozzle to the vessel shell.
